(19) United States
(12) Patent Application Publication
(10) Pub. No.: US 2023/0374416 A1
(43) Pub. Date: Nov. 23, 2023

(54) DRAIN CLEANER

(71) Applicant: CW ECO Solutions Inc., Carle Place, NY (US)

(72) Inventors: Burak Durukan, Gunesli Bagcilar (TR); Ömer Memis, Gunesli Bagcilar (TR)

(21) Appl. No.: 17/750,827

(22) Filed: May 23, 2022

(51) Int. Cl. C11D 3/04; C11D 1/29; C11D 3/20; C11D 17/06

(52) U.S. Cl. CPC C11D 3/046; C11D 1/29; C11D 3/2086; C11D 17/06

(57) ABSTRACT

A drain cleaner and methods for the production thereof are disclosed. The methods may include depositing a first salt into a chamber. The methods include depositing a first salt into a closed powder mixer. The methods include depositing an organic acid into the closed powder mixer. The methods include mixing the first salt and the organic acid to produce a first homogeneous mixture. The methods include depositing a second salt into the closed powder mixer. The methods include mixing the first homogeneous mixture and the second salt to produce a second homogeneous mixture. The methods include dosing the second homogeneous mixture with a surfactant to produce the drain cleaner.

### BACKGROUND

Drain cleaners may be used to remove a variety of materials which can cause clogging or restriction of wastewater drains. Chemical drain cleaners may include acids, bases, enzymes, solvents, reducing agents, oxidants and bioorganic compounds. Drain cleaners may be dry compounds which generate foam when mixed with water in a drain, liquids, or liquid gels.

### SUMMARY

In one example, the present disclosure relates to methods to produce a drain cleaner. The methods include depositing a first salt into a closed powder mixer. The methods include depositing an organic acid into the closed powder mixer. The methods include mixing the first salt and the organic acid to produce a first homogeneous mixture. The methods include depositing a second salt into the closed powder mixer. The methods include mixing the first homogeneous mixture and the second salt to produce a second homogeneous mixture. The methods include dosing the second homogeneous mixture with a surfactant to produce the drain cleaner.

In aspects, the first salt is sodium bisulfate.

In aspects, the second salt is sodium hydrogencarbonate.

In aspects, the organic acid is tartaric acid.

In aspects, the surfactant is sodium laureth sulfate.

In aspects, the first salt is sodium bisulfate, the second salt is sodium hydrogencarbonate, the organic acid is tartaric acid, and the surfactant is sodium laureth sulfate.

In aspects, the drain cleaner includes at least 30% by weight sodium bisulfate, less than 5% by weight sodium hydrogencarbonate, less than 10% by weight tartaric acid, and less than 5% by weight sodium laureth sulfate.

In aspects, the sodium bisulfate is 80-95% by weight of the drain cleaner.

In aspects, the method further includes feeding the drain cleaner into a hopper of an automatic filling machine and filling and sealing packages with a predetermined amount of the drain cleaner.

In some examples, systems to produce a drain cleaner are described. The systems include a closed powder mixer, a gravimetric automatic dosing system, and an automatic filling machine. The closed powder mixer is configured to receive a first salt and an organic acid and mix the first salt and the organic acid to produce a first homogeneous mixture. The closed powder mixer is further configured to receive a second salt and mix the first homogeneous mixture and the second salt to produce a second homogeneous mixture. The gravimetric automatic dosing system is configured to receive the second homogeneous mixture and dose the second homogeneous mixture with a surfactant. The automatic filling machine is configured to fill and seal packages with a predetermined amount of the drain cleaner.

In some examples, a drain cleaner is described. The drain cleaner includes at least 30% by weight sodium bisulfate, less than 5% by weight sodium hydrogencarbonate, less than 10% by weight tartaric acid, and less than 5% by weight sodium laureth sulfate

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to produce a drain cleaner in accordance with the present disclosure; and

FIG. 2 illustrates a flow diagram of an example process to produce a drain cleaner in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

It will be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof.

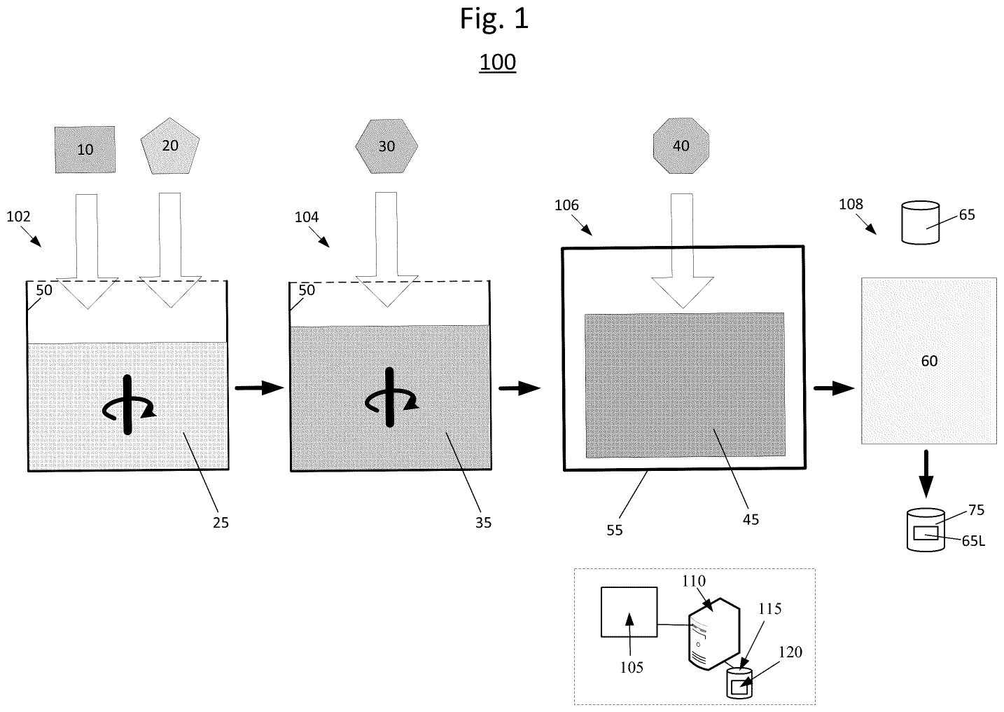

FIG. 1 illustrates an example system that can be utilized to produce a drain opener composition, arranged in accordance with at least some embodiments presented herein. As discussed in more detail below, a drain opener composition may be effective to clean and remove materials which may cause clogging or restriction of wastewater drains.

System 100 may include a compound 10, a compound 20, a compound 30, a compound 40, a closed powder mixer 50, a gravimetric automatic dosing system 55, and an automatic filling machine 60. Compound 10 may be a salt and may be a sodium salt of a bisulfate anion. Compound 10 may be an acid salt. Compound 10 may react with oxidizing agents. Compound 10 may include a sodium cation (Na⁺) and a bisulfate anion (HSO₄⁻). Compound 10 may be sodium bisulfate, also referred to as sodium bisulphate, bisulfate of soda, sodium acid sulfate, mono sodium hydrogen sulfate, sodium hydrogen sulfate, sodium hydrosulfate, and sulfuric acid sodium salt. Compound 10 may be sodium bisulfate in acidic form. Compound 10 may lower pH and a 1M solution of compound 10 may have a pH of around 1. Compound 10 may include sodium bisulfate with a formula NaHSO₄. A grain size of compound 10 may be from about 0.1 μ to about 41.0 μ. At 102, compound 10 may be deposited into closed powder mixer 50.

Compound 20 may be an organic acid. Compound 20 may be an alpha-hydroxy-carboxylic acid and may be diprotic and aldric. Compound 20 may be tartaric acid, also referred to as dihydroxybutanedioic acid, cream of tartar, levotartaric acid, dextrotartaric acid, mesotartaric acid, racemic tartaric acid, and racemic acid. Compound 20 may chelate metal ions and be used for cleaning of metal surfaces. Compound 20 may be tartaric acid with a formula C₄H₆O₆. A grain size of compound 20 may be about 100 id. At 102, compound 20 may be deposited into closed powder mixer 50.

At 102, closed powder mixer 50 may mix compound 10 with compound 20 at 40-45 rpm for about 2.0 hours at 20-25 degrees Celsius and 10-15% relative humidity to produce mixture 25. Mixture 25 may have a weight ratio (% w/w) of compound 10 to compound 20 of 47.5:1 through 8:1. Mixture 25 may be mixed by closed powder mixer 50 until homogeneous.

Compound 30 may be a salt and may be a sodium salt of a bicarbonate anion. Compound 30 may include a sodium cation (Nat) and a bicarbonate anion (HCO₃⁻). Compound 30 may be sodium hydrogencarbonate, also referred to as sodium bicarbonate, baking soda, bread soda, cooking soda, and bicarbonate of soda. Compound 30 may neutralize acid solutions. Compound 30 may work as an antiseptic. Compound 30 may provide a composition including compound 30 to disperse within a drain. Compound 30 may be sodium hydrogencarbonate with a formula NaHCO₃. A grain size of compound 30 may be from about 47 μ to about 308 μ. At 104, compound 30 may be deposited into closed powder mixer 50 to be added to mixture 25.

At 104, closed powder mixer 50 may mix compound 30 with mixture 25 at 40-45 rpm for about 1.0 hours at 20-25 degrees Celsius and 10-15% relative humidity to produce mixture 35. Mixture 35 may have a weight ratio (% w/w) of mixture 25 to compound 30 of 98:1 through 20:1. Mixture 35 may be mixed by closed powder mixer 50 until homogeneous.

Compound 40 may be a surfactant and an anionic detergent. Compound 40 may be sodium laureth sulfate, also referred to as sodium lauryl ether sulfate (SLES) and sodium alkylethersulfate. Compound 40 may be a foaming agent and may include cleaning and emulsifying properties. Compound 40 may be sodium laureth sulfate with a formula CH₃CH₂)₁₁(OCH₂CH₂)ₙOSO₃Na. Mixture 35 may be removed from closed powder mixer 50 and placed into gravimetric automatic dosing system 55.

At 106, mixture 35 may be slowly dosed with compound 40 by gravimetric automatic dosing system 55 for about 2.0 hours at 20-25 degrees Celsius and 10-15% relative humidity to produce mixture 45. Gravimetric automatic dosing system 55 may perform automated gravimetric dosing with continuous weighing. Gravimetric automatic dosing system 55 may include an operator panel 105, a processor 110, and a memory 115 including instructions for dosing 120. An operator of gravimetric automatic dosing system 55 may input parameters into operator panel 105 for dosing of mixture 35 with compound 40. Gravimetric automatic dosing system 55 may continuously weight mixture 35 and mixture 45 during dosing with compound 40 in order to eliminate errors in quality, production and color in dosed mixture 45 due to changes in a bulk density of the material during dosing. Gravimetric automatic dosing system 55 may perform gravimetric dosing based on precision balance and may include a scale with a weight sensitivity of 0.1% (one thousandth).

Mixture 45 may have a weight ratio (% w/w) of mixture 35 to compound 40 of 99:1 through 19:1. Mixture 45 may be homogeneous. Mixture 45 may be a fine white powder with clear colorless to slightly yellow colored crystals. Mixture 45 may include: at least 30% by weight of compound 10; less than 10% by weight of compound 20; less than 5% by weight of compound 30; and less than 5.0% by weight of compound 40. Mixture 45 may include: 80-95% by weight of compound 10; 2.0-10.0% by weight of compound 20; 1.0-5.0% by weight of compound 30; and 1.0-5.0% by weight of compound 40. Mixture 45 may be suitable as a drain opener composition and may remove a variety of materials and unclog a drain or restriction within a wastewater drain.

At 108, mixture 45 may be fed into a hopper of automatic filling machine 60. Automatic filling machine 60 may fill and seal packages 65 with a predetermined amount of mixture 45 to generate product 70. Packages 65 may be water resistant. Packages 65 may be polypropylene cups and may further include a label 65L.

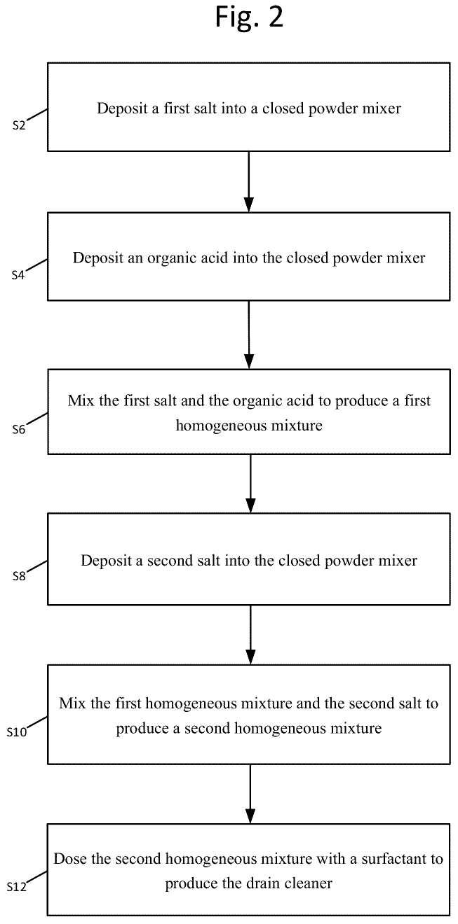

FIG. 2 illustrates a flow diagram of an example process to produce the present drain opener compositions. The process in FIG. 2 could be implemented using, for example, system 100 discussed above. An example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

Processing may begin at block S2, “Deposit a first salt into a closed powder mixer.” At block S2, a first salt (e.g., NaHSO₄) may be deposited into closed powder mixer 50.

Processing may continue from block S2 to block S4, “Deposit an organic acid into the closed powder mixer.” At block S4, an organic acid (e.g., tartaric acid) may be deposited into closed powder mixer 50.

Processing may continue from block S4 to block S6, “Mix the first salt and the organic acid to produce a first homogeneous mixture.” At block S6, closed powder mixer 50 may mix the first salt and the organic acid to produce a first homogeneous mixture. The first homogeneous mixer may have a weight ratio (% w/w) of the first salt to the organic acid of 47.5:1 through 8:1.

Processing may continue from block S6 to block S8, “Deposit a second salt into the closed powder mixer.” At block S8, a second salt (e.g., NaHCO₃) may be deposited into closed powder mixer 50.

Processing may continue from block S8 to block S10, “Mix the first homogeneous mixture and the second salt to produce a second homogeneous mixture.” At block S10, closed powder mixer 50 may mix the first homogeneous mixture and the second salt to produce a second homogeneous mixture.

Processing may continue from block S10 to block S12, “Dose the second homogeneous mixture with a surfactant to produce the drain cleaner.” At block S12, the second homogeneous mixture may be dosed with a surfactant (e.g., sodium laureth sulfate) to produce the drain cleaner.

A system in accordance with the present disclosure may be an effective to produce a drain opener composition. An embodiment of the present application may be highly stable and remove a variety of materials which can cause clogging or restriction of wastewater drains. An embodiment of the present application may generate foam when mixed with water in a drain to unclog a wastewater drain. An embodiment of the present application may sanitize a drain while unclogging a wastewater drain. An embodiment of the present application may remove a variety of materials which can cause clogging or restriction of wastewater drains without producing heat.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method to produce a drain cleaner, the method comprising:
depositing a first salt into a closed powder mixer;
depositing an organic acid into the closed powder mixer;
mixing the first salt and the organic acid to produce a first homogeneous mixture;
depositing a second salt into the closed powder mixer;
mixing the first homogeneous mixture and the second salt to produce a second homogeneous mixture; and
dosing the second homogeneous mixture with a surfactant to produce the drain cleaner.

2. The method of claim 1, wherein the first salt is sodium bisulfate.

3. The method of claim 1, wherein the second salt is sodium hydrogencarbonate.

4. The method of claim 1, wherein the organic acid is tartaric acid.

5. The method of claim 1, wherein the surfactant is sodium laureth sulfate.

6. The method of claim 1, wherein:
the first salt is sodium bisulfate;
the second salt is sodium hydrogencarbonate;
the organic acid is tartaric acid; and
the surfactant is sodium laureth sulfate.

7. The method of claim 6, wherein the drain cleaner includes:
at least 30% by weight sodium bisulfate;
less than 5% by weight sodium hydrogencarbonate;
less than 10% by weight tartaric acid; and
less than 5% by weight sodium laureth sulfate.

8. The method of claim 6, the sodium bisulfate is 80-95% by weight of the drain cleaner.

9. The method of claim 1, further comprising:
feeding the drain cleaner into a hopper of an automatic filling machine; and
filling and sealing packages with a predetermined amount of the drain cleaner.

10. A system to produce a drain cleaner, the system comprising:
a closed powder mixer;
a gravimetric automatic dosing system; and
an automatic filling machine;
wherein:
the closed powder mixer is configured to:
receive a first salt and an organic acid;
mix the first salt and the organic acid to produce a first homogeneous mixture;
receive a second salt; and
mix the first homogeneous mixture and the second salt to produce a second homogeneous mixture;
the gravimetric automatic dosing system is configured to receive the second homogeneous mixture and dose the second homogeneous mixture with a surfactant; and
the automatic filling machine is configured to fill and seal packages with a predetermined amount of the drain cleaner.

11. The system of claim 10, wherein the first salt is sodium bisulfate.

12. The system of claim 10, wherein the second salt is sodium hydrogencarbonate.

13. The system of claim 10, wherein the organic acid is tartaric acid.

14. The system of claim 10, wherein the surfactant is sodium laureth sulfate.

15. The system of claim 10, wherein:
the first salt is sodium bisulfate;
the second salt is sodium hydrogencarbonate;
the organic acid is tartaric acid; and
the surfactant is sodium laureth sulfate.

16. The system of claim 15, wherein the drain cleaner includes:
at least 30% by weight sodium bisulfate;
less than 5% by weight sodium hydrogencarbonate;
less than 10% by weight tartaric acid; and
less than 5% by weight sodium laureth sulfate.

17. The system of claim 16, the sodium bisulfate is 80-95% by weight of the drain cleaner.

18. A drain cleaner comprising:
at least 30% by weight sodium bisulfate;
less than 5% by weight sodium hydrogencarbonate;
less than 10% by weight tartaric acid; and
less than 5% by weight sodium laureth sulfate.

19. The drain cleaner of claim 18, wherein the drain cleaner is a powder.

20. The drain cleaner of claim 18, wherein the sodium bisulfate is 80-95% by weight of the drain cleaner.
